(19) United States
(12) Patent Application Publication
(10) Pub. No.: US 2025/0128420 A1
(43) Pub. Date: Apr. 24, 2025

(54) METHODS, SYSTEMS AND APPARATUSES FOR EQUIPMENT ALIGNMENT AND POSITION TEACH

(71) Applicant: AEM Singapore Pte. Ltd., Singapore (SG)

(72) Inventors: Mac Zhang, Singapore (SG); Raymond Ngiam, Singpore (SG); Oscar Tan, Singapore (SG); Yam Kwang (Derrick) Chua, Singapore (SG)

(73) Assignee: AEM Singapore Pte. Ltd., Singapore (SG)

(21) Appl. No.: 18/722,267

(22) PCT Filed: May 9, 2023
(86) PCT No.: PCT/SG2023/050323

§ 371 Date: Jun. 20, 2024

(30) Foreign Application Priority Data
May 9, 2022 (SG) 10202204854P

(51) Int. Cl. B25J 9/16; B25J 9/00; B65G 61/00

(52) U.S. Cl. CPC B25J 9/1692; B25J 9/0081; B25J 9/1697; B65G 61/00

(57) ABSTRACT

Methods, systems and apparatuses for equipment alignment and position teach are provided. According to another aspect of the present embodiments, a system for pick-and-place calibration of a pick-and-place machine is provided. The system comprises a universal teach apparatus, a computing means, and a motor control means. The universal teach apparatus is configured to teach pick-and-place positions and is coupleable to a pick head of the pick-and-place machine. The universal teach apparatus includes imaging means for capturing images in-line with a center of the pick head. The computing means is coupled to the universal teach apparatus to receive the captured images and is configured to generate at least one virtual image corresponding to one or more parameters of the captured images. And the motor control means is coupled to the computing means, the pick head of the pick-and-place machine, and the universal teach apparatus and is configured to move the pick head under control of the computing means and/or the universal teach apparatus. During a process of teaching pick-and-place positions, the computing means is configured to adjust a pick head position via the motor control means based on alignment of the center of the pick head with the at least one virtual image and is further configured to record a plurality of coordinate parameters corresponding to position data of the motor control means when the center of the pick head fully and accurately aligns with the at least one virtual image.

### PRIORITY CLAIM

This application claims priority from Singapore Patent Application No. 10202204854P filed on 9 May 2022.

### TECHNICAL FIELD

The present invention generally relates to machine assembly vision systems, and more particularly relates to methods, systems and apparatuses for equipment alignment and position teach.

### BACKGROUND OF THE DISCLOSURE

A commonplace machine in component placement systems is commonly called a pick-and-place machine. Pick-and-place machines are robotic machines which are used for high speed, high precision placing of a broad range of electronic components and other small devices. Current methods of pick and place in such machines use cameras and machine vision to locate landmark positions, called fiducials, for accuracy and precision of pick and place operations.

One application for such pick-and-place machines is in backend semiconductor testing where high throughput and high precision placement of semiconductor devices under test is a requirement. However, there are several challenges to camera vision pick and place operations in such high throughput, high precision systems. First, the straightness of a pick head extension structure where the end effector pick head is attached, such as a ball screw, will result in error in a x-y pick location if the ball screw is not orthogonal to the pick and place plane. Further, the mounting direction of the camera system used for locating fiducial in the pick and place plane will result in error in the x-y pick location if the camera optical axis is not orthogonal to the pick and place surface plane as the non-orthogonal camera optical axis will give rise to erroneous coordinate correction feedback being provided by the camera system.

While software methods have been used to compensate for some errors, mechanical stack up tolerances resulting from errors in soft touch, tester columns, testers, docking pin, and pick head arm rotation cannot be accurately represented by current compensation mathematical models.

Thus, there is a need for vision systems and methods and apparatuses for equipment alignment which overcomes the drawbacks of current systems and methods and provides a more efficient, higher precision and universally applicable high throughput machine assembly stack up tolerance compensating solution. Furthermore, other desirable features and characteristics will become apparent from the subsequent detailed description and the appended claims, taken in conjunction with the accompanying drawings and this background of the disclosure.

### SUMMARY

According to at least one aspect of the present embodiments, a universal teach apparatus for teaching pick-and-place positions is provided. The universal teach apparatus includes a reflective material, a camera, means for mounting the universal teach apparatus, and an adjustment means. The camera is located in relation to the reflective material to receive image information from a first reflective face of the reflective material. The means for mounting the universal teach apparatus is configured to mount the universal teach apparatus onto a pick head of a pick-and-place machine with a second reflective face of the reflective material facing the pick head. And the adjustment means is coupled to one or both of the camera and the reflective material and configured to adjust a field of view of the camera to view the reflective material, configured to adjust a focal distance of the camera to focus on the reflective material, and/or configured to adjust a center of the second reflective face of the reflective material with a center of the pick head.

According to another aspect of the present embodiments, a system for pick-and-place calibration of a pick-and-place machine is provided. The system comprises a universal teach apparatus, a computing means, and a motor control means. The universal teach apparatus is configured to teach pick-and-place positions and is coupleable to a pick head of the pick-and-place machine. The universal teach apparatus includes imaging means for capturing images in-line with a center of the pick head. The computing means is coupled to the universal teach apparatus to receive the captured images and is configured to generate at least one virtual image corresponding to one or more parameters of the captured images. And the motor control means is coupled to the computing means, the pick head of the pick-and-place machine, and the universal teach apparatus and is configured to move the pick head under control of the computing means and/or the universal teach apparatus. During a process of teaching pick-and-place positions, the computing means is configured to adjust a pick head position via the motor control means based on alignment of the center of the pick head with the at least one virtual image and is further configured to record a plurality of coordinate parameters corresponding to position data of the motor control means when the center of the pick head fully and accurately aligns with the at least one virtual image.

According to yet a further aspect of the present embodiments, a method to resolve stack up tolerances in a machine assembly comprising a pick-and-place machine and using a universal teach apparatus including an image capturing device is provided. The method includes mounting the universal teach apparatus to a pick head of the pick-and-place machine and using the image capturing device of the universal teach apparatus to capture images of defined markings on one or more products to be picked by the pick-and-place machine and/or trays for holding the products to be picked, wherein the defined markings comprise fiducial markings. The method further includes generating one or more virtual parameters from the captured images, the one or more virtual parameters corresponding at least to a center of the one or more products and/or trays and a size and/or shape of the one or more products and/or trays, generating a virtual product outline based one the one or more virtual parameters, and calibrating the pick-and-place machine in response to the virtual product outline to resolve stack up tolerances of a pick-and-place operation of the pick-and-place machine.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1, comprising FIGS. 1A to 1D, depicts illustrations of a universal teach kit in accordance with present embodiments, wherein FIG. 1A depicts a first perspective view, FIG. 1B depicts a top planar view, FIG. 1C depicts a side planar view, and FIG. 1D depicts a second perspective view.

FIG. 2, comprising FIGS. 2A to 2C, depicts illustrations of a vertical pick head with attached universal teach kit in accordance with present embodiments, wherein FIG. 2A depicts a top planar view of the vertical pick head, FIG. 2B depicts an enlarged top planar view of a device under test (DUT) coupon, and FIG. 2C depicts an enlarged top planar view of the attached universal teach kit.

FIG. 3, comprising FIGS. 3A and 3B, depicts top side perspective views of the vertical pick heads in accordance with the present embodiments with and without the universal teach kits, wherein FIG. 3A depicts a view of the vertical pick heads without the universal teach kits and FIG. 3B depicts a view of the vertical pick heads with the universal teach kits.

FIG. 4, comprising FIGS. 4A and 4B, depicts enlarged top side perspective views of a single vertical pick head in accordance with the present embodiments with and without a universal teach kit, wherein FIG. 4A depicts a view of the vertical pick head without the universal teach kits and FIG. 4B depicts a view of the vertical pick head with the universal teach kits.

FIG. 5, comprising FIGS. 5A to 5C, depicts illustrations of a horizontal pick head in accordance with present embodiments, wherein FIG. 5A depicts a top planar view of the horizontal pick head view, FIG. 5B depicts an enlarged top planar view of the universal teach kit, and FIG. 5C depicts an enlarged top planar view of a DUT coupon.

FIG. 6, comprising FIGS. 6A and 6B, depicts enlarged top side perspective views of horizontal pick heads in accordance with the present embodiments with and without a universal teach kit, wherein FIG. 6A depicts a view of the horizontal pick heads without the universal teach kits and FIG. 6B depicts a view of the horizontal pick heads with the universal teach kits.

FIG. 7, comprising FIGS. 7A and 7B, depicts side planar views of a single horizontal pick head in accordance with the present embodiments with and without a universal teach kit, wherein FIG. 7A depicts a view of the horizontal pick head without the universal teach kit and FIG. 7B depicts a view of the horizontal pick head with the universal teach kit.

FIG. 8, comprising FIGS. 8A to 8D, depicts illustrations of an operation of an input/output (IO) module for acquisition of datum fiducial points in accordance with the present embodiments, wherein FIG. 8A depicts pick-and-place machine's pick heads at a start of the operation, FIG. 8B depicts a universal teach kit attached to a first pick-and-place machine's pick head acquiring an image of the datum fiducial point during the operation, FIG. 8C depicts a DUT coupon picked by the pick head during the operation, and FIG. 8D depicts one of the datum fiducial points of a tray of DUT coupons.

FIG. 9 depicts a view of a tray of DUT coupons for a method for teaching alignment using the universal teaching kit in accordance with the present embodiments.

FIG. 10, comprising FIGS. 10A and 10B, depicts images of DUT coupons for determining a center of the DUT coupon for the method of teaching alignment in accordance with the present embodiments, wherein FIG. 10A depicts a process of locating the center of the DUT coupon and FIG. 10B depicts an enlarged DUT coupon showing the located center of the DUT coupon.

FIG. 11 depicts a view of the tray of DUT coupons with the center of the DUT coupons located in accordance with the present embodiments.

FIG. 12 depicts a view of the tray of DUT coupons mapped with initial virtual lines for locating a center point of each of the device holders/sockets therein in accordance with the present embodiments.

FIG. 13 depicts a view of the tray of DUT coupons mapped with locations of the center point of each of the device holders/sockets therein in accordance with the present embodiments.

FIG. 14 depicts a top view illustration of a closed loop system of two modules synchronized in terms of a transfer mechanism in accordance with the present embodiments.

FIG. 15 depicts a top view illustration of a transfer mechanism of the closed loop system of FIG. 14 in accordance with the present embodiments.

FIG. 16 depicts a top front perspective view of DUT coupons on a first row of the precisor ready for calibration and alignment by the universal teach kits in accordance with the present embodiments.

FIG. 17 depicts a top front perspective view of the DUT coupons picked from the first row of the precisor and placed on a second row of the precisor for pick-and- place to test columns in accordance with the present embodiments.

FIG. 18 depicts a top, back, right perspective of a transfer robot (TBOT) and transfer modules with the four universal test kits mounted on the pick heads for calibration of place position of the DUT coupons in accordance with the present embodiments.

FIG. 19 depicts an enlarged top, back, right perspective of the end effectors of the TBOT with the four universal test kits mounted on the pick heads in position for calibration of the place position the DUT coupons within the sockets of the first row of the precisor in accordance with the present embodiments.

FIG. 20 depicts an illustration of the precisor before generation of virtual product outlines (VPOs) in accordance with the present embodiments.

FIG. 21 depicts an illustration of the precisor after generation of VPOs in accordance with the present embodiments.

FIG. 22 depicts an illustration of the DUT coupons on a fixture of a test column before generation of VPOs in accordance with the present embodiments.

FIG. 23 depicts an illustration of the DUT coupons on a fixture of a test column after generation of the VPOs in accordance with the present embodiments

FIG. 24, comprising FIGS. 24A and 24B, depicts illustrations a first case study of a VPO recording based on a pick-and-place operation in accordance with the present embodiments where the DUT coupon is placed squarely within the device module or socket.

FIG. 25, comprising FIGS. 25A and 25B, depicts illustrations a second case study of a VPO recording based on a pick-and-place operation in accordance with the present embodiments where the DUT coupon is placed out of position (OOP) within the device module or socket.

FIG. 26 is an illustration of the linkage between the recorded VPOs of the precisor module and the TBOT and test column module in accordance with the present embodiments.

FIG. 27, comprising FIGS. 27A to 27C, depicts three steps in use of the virtual boundary to optimize defining of the virtual product outline in accordance with the present embodiments.

FIG. 28, comprising FIGS. 28A to 27H, depicts different fiducial shapes which can be defined on the DUT coupons in accordance with the present embodiments.

FIG. 29 depicts a different design of a test column having multiple fixture or jigs arranged thereon in accordance with the present embodiments.

FIG. 30 depicts a flowchart of a calibration process in accordance with the present embodiments which uses the universal test kit to bypass the machine stack up tolerances.

FIG. 31 depicts a flowchart of a vision image auto processing method in accordance with the present embodiments to generate all center points of all device holders or sockets or slots in a tray.

And FIG. 32 depicts a flowchart of a process to generate a closed loop for pick-and-place positions in a multi module system in accordance with the present embodiments.

Skilled artisans will appreciate that elements in the figures are illustrated for simplicity and clarity and have not necessarily been depicted to scale.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of present embodiments to present a vision system and an apparatus and method for equipment alignment to resolve stack up tolerances in a machine assembly. In accordance with present embodiments, a novel alignment method is used to bypass and overcome stack up tolerances by directly aligning a pick head center and a pick-and-place location plane center using a universal teach system which includes alignment kits, cameras, and motor control systems. The universal teach kit described herein refers to any device/tooling that consists of a camera or camera module that is mounted directly to a pick head of a pick-and-place device. Use of the universal teach kit in accordance with the present embodiments advantageously overcomes all tolerance stack up issues and enables direct calibration or tuning of a machine or tooling based on actual images or fiducial points collected for the calibration. The calibration and teach methodologies and the universal teach system in accordance with the present embodiments auto aligns two or more alignment kits by moving motors in the x-y-z-r directions (i.e., Cartesian coordinate directions “x-y-z” and rotation direction “r”). After auto alignment, the system in accordance with the present embodiments saves absolute x-y-z-r motor positions for the pick-and-place locations where alignment is achieved, generating a center point and virtual product outline for operational alignment purposes and enabling a closed loop system among two or more modules.

The alignment systems and methods in accordance with the present embodiments also addresses the challenge of pick-and-place teaching for different sizes of units, such as test units, and different types of packaging; reduces setup time; and enables offline simulation based on collected data points. The overall system accuracy is transformed from addressing these challenges focused on the unit size, shape and packaging to how mechanically the center of the universal teach kit prism aligns with the center of the pick-and-place suction cup (i.e., a single mechanical alignment of the system rather than an alignment issue with each unit. As the camera pixel resolution can be equal to or better than the pick-and-place machine's motor accuracy, the camera axis accuracy in the x-axis, the y-axis, the z-axis, and the r-rotation will not impact the overall system accuracy.

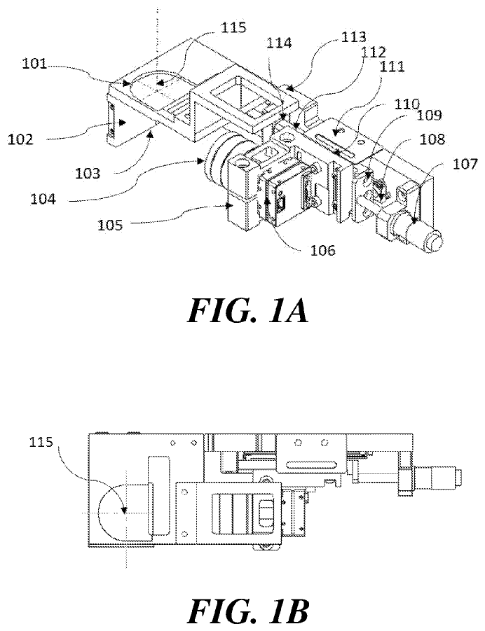

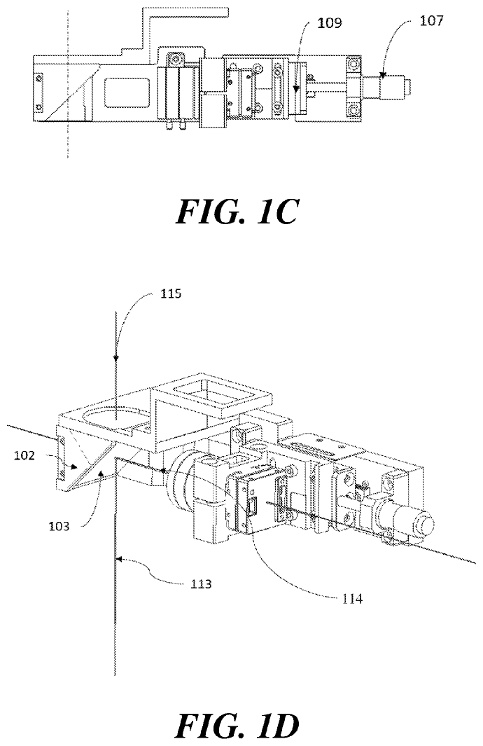

FIGS. 1A, 1B, 1C and 1D depict illustrations of a universal teach kit 100 in accordance with present embodiments, wherein FIG. 1A depicts a first perspective view, FIG. 1B depicts a top planar view, FIG. 1C depicts a side planar view, and FIG. 1D depicts a second perspective view. The universal teach kit in accordance with the present embodiments can be mounted to a pick head of an industrial or non-industrial pick-and-place machine which is targeted to collect and analyze data based on pixels within a digital image (generally consisting of fiducial marks) to match the pick head center thereto mainly for alignment improvement and to define a calibrated position. The data is then used for vision processing by virtual center point and/or visual product outline generation for calibration and alignment during pick-and-place operations. In accordance with the present embodiments, a method of vision alignment is provided which generates different cases and defines best conditions in reference to data points and virtual boundary data collected in order to advantageously provide a vision alignment system and method which significantly improves any machine accuracy by generating vision alignment through simulation instead of using actual product vision.

In addition, a key factor that is critical for any machinery or production is placement accuracy. The universal teach kit and novel alignment method in accordance with the present embodiments addresses stack up tolerance issues in a machine assembly or when different modules are link up together in a system. Stack up tolerances are known issues for much of the engineering industry whereby the ideal case of mechanical position, calculated position and position from a CAD model is an ideal condition existing in an ideal world. However, in the real world, stack up tolerance between assemblies and modules joining as a system do not have a universal method to validate and check the system resulting in increased engineering and setup time used for system setup and machine re-tuning. Costs will be indirectly impacted due to these stack up tolerance issues.

The universal teach kit 100 includes a support/holder 102 for a prism 103. A precision fabrication part 101 and associated centralized jig enables mounting of the universal teach kit 100 onto a center of the pick head directly and relatively to the prism 103 center and field of view. The prism 103 is a 45° prism with adjustable prism angle and includes any reflective mirror or device to translate an image to a camera lens 104 on a camera 106 across a short distance between the prism 103 and the lens 104.

The camera 106 is selected to provide a sufficient field of view and providing an image resolution in the range of two to five megapixels or more. The camera 106 and the lens 104 are mounted to the universal teach kit 100 by a mounting device 105 such as a C-bracket holder. The universal teach kit 100 includes adjustable working distances, angles and positions of the prism 103 at which a line of vision of the camera 106 and the lens 104 is parallel to the prism 103.

A gauge 107 provides focal distance adjustment for the camera 106 in the micrometer range and is connected to the camera 106 and the lens 104 by a block 109 and a slider 108 attached to a base 110 which holds the camera 106 and the lens 104 and other mounting means. The gauge 107 enables adjustment of the distance from the base 110 to the prism 103. A biasing device includes a spring 112 and a holder 114 attached to the base 110 to support biased adjustment of the camera 106 and the lens 104 mounted on the base 110 while maintaining progressive positioning during adjustment.

A side bracket 111 enables locking a position of the camera and lens module once the camera 106 and the lens 104 distance to the prism 103 is adjusted for optimal focal distance. While any locking mechanism may be utilized for the side bracket 111, use of a Nord-Lock™ solution such as locking washers from Nord Lock International AB of Malmo, Sweden is recommended for full locking of the camera and lens module which would not be affected by vibrations during pick-and-place operations.

A base 113 is a main base for mounting of the slider 108, the camera and lens base 110 and the prism 103 and its holder 102. Dashed lines 115 indicate where a center position of a pick head of the pick-and-place machine is to be aligned relative to the universal teach kit 100 for proper mounting of the universal teach kit 100 to align a center of the prism 103 and a center of the pick head.

While the universal teach kit 100 is shown as having a substantially cuboid shape, the design of the universal teach kit 100 can be revised to have an angular shape for the case where the overall pick-and-place assembly needs to travel at any angular position. To ensure the universal teach kit 100 translates an actual image in relation to the center of the pick head, the universal teach kit 100, particularly the prism 103 and the focal center of the camera 106, needs to be calibrated offline using a precision calibration tool.

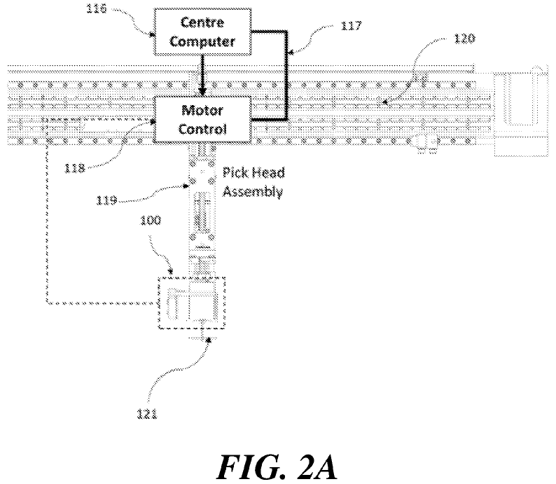

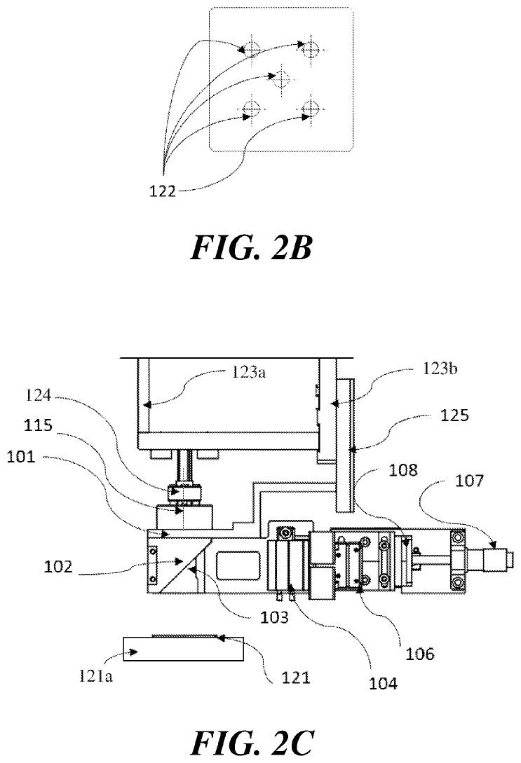

FIGS. 2A, 2B and 2C depict illustrations of a vertical pick head assembly 119 with the universal teach system 100 attached in accordance with present embodiments, where FIG. 2A depicts a top planar view of the vertical pick head assembly 119, FIG. 2B depicts an enlarged top planar view of a device under test (DUT) coupon 121, and FIG. 2C depicts an enlarged top planar view of the attached universal teach kit 100.

Referring to FIG. 2A, a centre computer 116 is coupled to a pick head motor control system 118 via a bilateral data transfer and communication connection. The centre computer 116 receives and processes camera information, position alignment, and calibrations and makes calculations to provide instructions the motor control system 118 for control thereof. The motor control system 118 can move the pick head assembly 119 in the x-axis, the y-axis and the z-axis, and can rotate the pick head assembly 119 in the r-axis. The pick head assembly 120 can also move back and forth along a slider 120 of the vertical pick assembly.

The universal teach kit 100 is mounted to the pick head assembly 119 and is coupled to the motor control 118 for communication with and operation of the motor control during a teach operation in accordance with the present embodiment as described hereinbelow. A device under test (DUT) coupon 121 is used by the universal teach kit 100 during the teach operation in accordance with the present embodiment and is a machined part which carries the same dimension as a final test DUT.

FIG. 2B depicts the DUT coupon 121 in accordance with the present embodiment. The DUT coupon 121 includes five fiducials 122. The fiducials are precision markings of 10×10mm, 7×7mm or 3×3mm and can be any type of fiducial markings as long as the vision system able to recognize and generate the virtual center of the DUT coupon 121. The selection of the fiducial/precision marking 122 is also dependent on the size of the DUT or product being picked. With proper mounting of the universal teach kit 100 to the pick head assembly 119 by the precision fabrication part 101 the center of the pick head assembly 119 is aligned with the center of the prism 103 and the DUT coupon 121 along the center position 115.

Referring to FIG. 2C, the enlarged view of the attached universal teach kit 100 attached to the pick head assembly 119 depicts attachment of the precision fabrication part 101 of the universal teach kit 100 to a pick head 124 of the pick head assembly 119 for universal teach kit fine alignment operations. The weight of the universal teach kit 100 is also supported by a front pick head support 123a and a back pick head support 123b, with a counterweight support 125 attached to the back pick head support 123b to even the support load of the universal teach kit 100 on the pick head 124. A DUT coupon support 121a supports the DUT coupon 121.

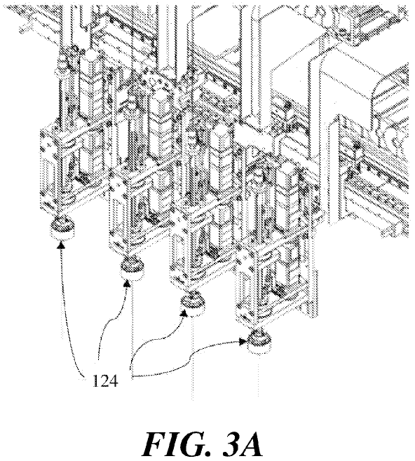

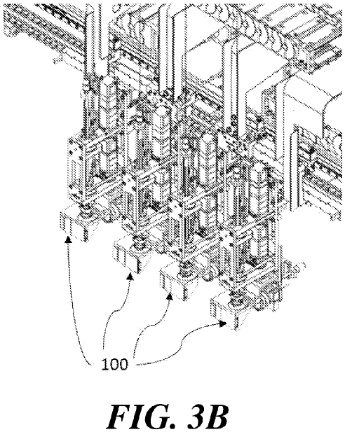

FIGS. 3A and 3B depict perspective views of the vertical pick heads in accordance with the present embodiments with and without the universal teach kits 100. Referring to FIG. 3A, it can be seen that the pick heads 124 are ready for pick-and-place operations without the universal teach kits 100 attached. In FIG. 3B, the universal teach kits 100 are attached to the pick heads 124 of the vertical pick heads for teach operations in accordance with the present embodiments. Depending of the number of pick-and-place devices or transfer mechanisms, each pick head 124 can have a universal teach kit 100 mounted. The mounting of the universal teach kit 100 is customized based on the design of the pick-and-place device. The critical point for this methodology is to have the prism 103 and the field of view center of the camera located at a center position of the pick head 124.

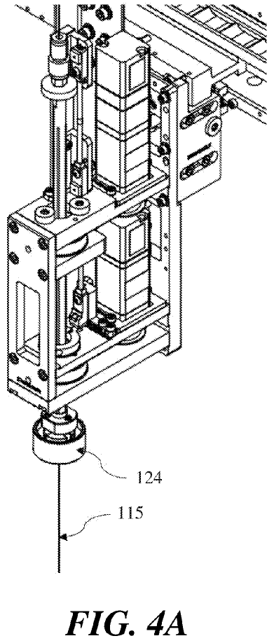

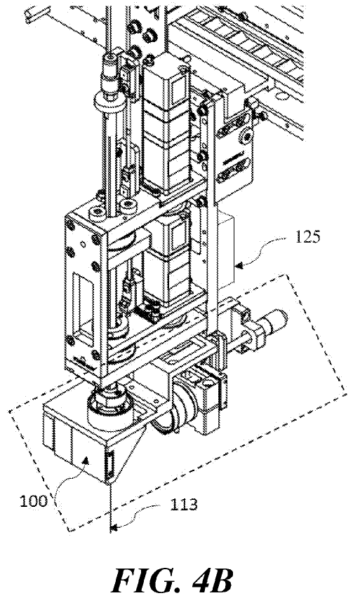

FIGS. 4A and 4B depict enlarged perspective views of a single vertical pick head in accordance with the present embodiments with and without the universal teach kit 100. Referring to FIG. 4A, the pick head 124 is ready for a pick-and-place operation whereby the center position 115 of the pick head 124 is aligned to a center of a component, device or DUT to be picked and placed. FIG. 4B depicts the universal teach kit 100 mounted on the vertical pick head 124 whereby the center position 115 of the pick head 124 is aligned with a center of the prism 103 of the universal teach kit 100 for teaching the pick head 124 a center of the component, device or DUT to be picked and placed during a teach operation in accordance with the present embodiments.

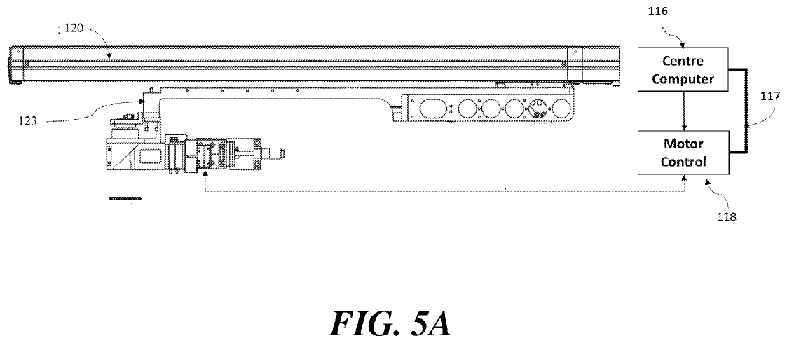

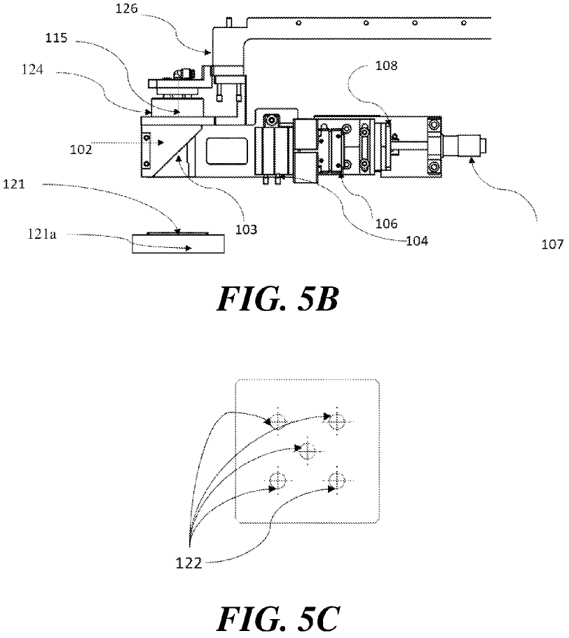

In addition to a pick-and-place machine utilizing a vertical pick assembly with a vertical pick head, some embodiments may require a pick-and-place machine utilizing a horizontal pick assembly with a horizontal pick head. The universal teach kit 100 may also be utilized with a horizontal pick head as shown in FIGS. 5A, 5B and 5C. FIG. 5A depicts a view of a horizontal pick head 124 with a universal teach kit 100 attached in accordance with the present embodiments. FIG. 5B depicts an enlarged view of the universal teach kit 100 and FIG. 5C depicts an enlarged view of the DUT coupon 121 with the fiducials 122.

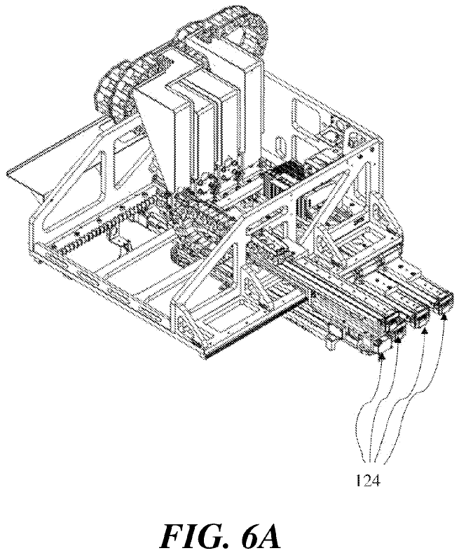

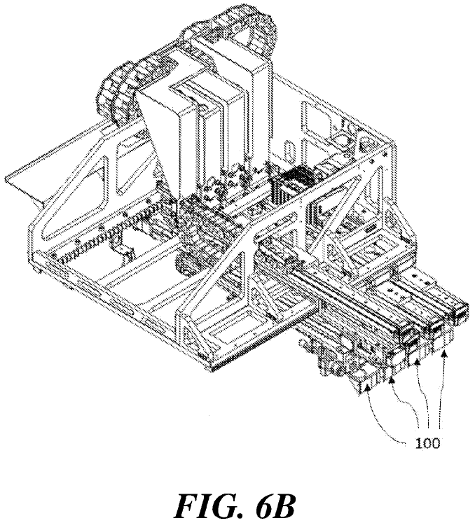

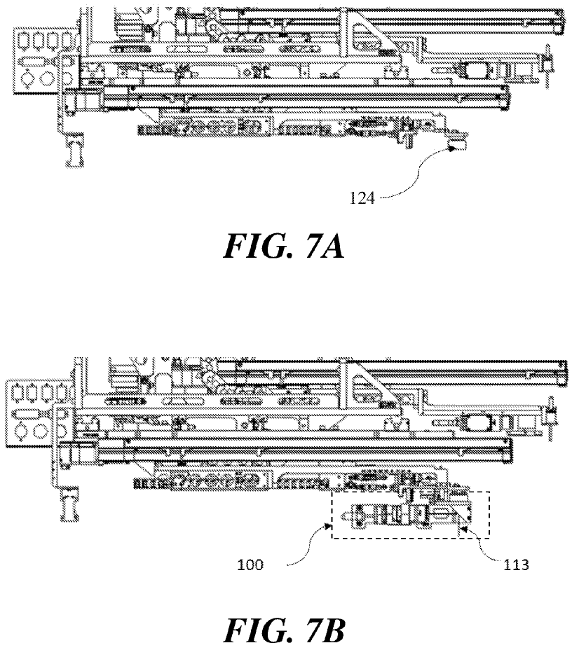

FIGS. 6A and 6B depict enlarged views of horizontal pick heads 124 with and without universal teach kits 100 in accordance with the present embodiments, where FIG. 6A depicts a view of the horizontal pick heads 124 without the universal teach kits 100 and FIG. 6B depicts a view of the horizontal pick heads 124 with the universal teach kits 100. FIGS. 7A and 7B depict views of a single horizontal pick head 124 with and without a universal teach kit 100 in accordance with the present embodiments, where FIG. 7A depicts a view of the horizontal pick head 124 without the universal teach kit 100 and FIG. 7B depicts a view of the horizontal pick head 124 with the universal teach kit 100.

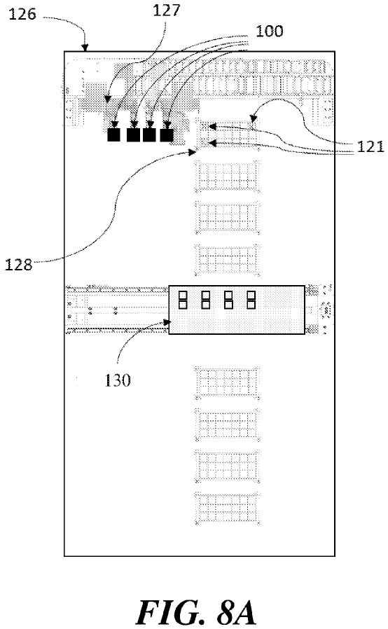

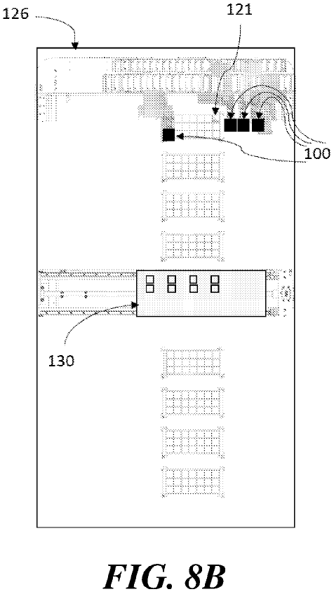

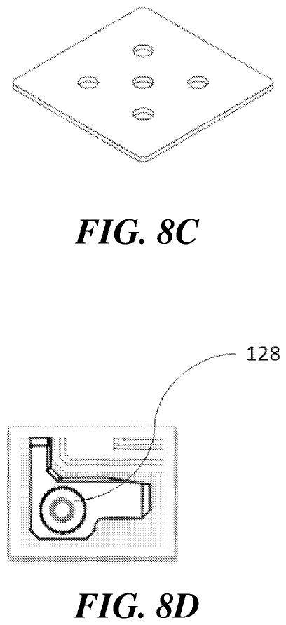

Referring to FIGS. 8A and 8B, an operation of an input/output (IO) module 126 for acquisition of datum fiducial points 128 in accordance with the present embodiment is depicted including a precisor 130 as described hereinbelow. A transfer module 127 with a defined numbers of pick heads 124 have universal teach kits 100 mounted thereon. As shown in FIG. 8C, the DUT coupon 121 has a form factor of the device to be tested (i.e., the DUT) and fiducials that the cameras 106 of the universal teach kits 110 can capture through different lighting and conditions. The illustration of FIG. 8B depicts how the first universal teach kit 100 acquires an image of the datum fiducial point 128 on a side guide 129 of the tray 131 to determine a reference point of the lane/tray 131 of the DUT coupons 121.

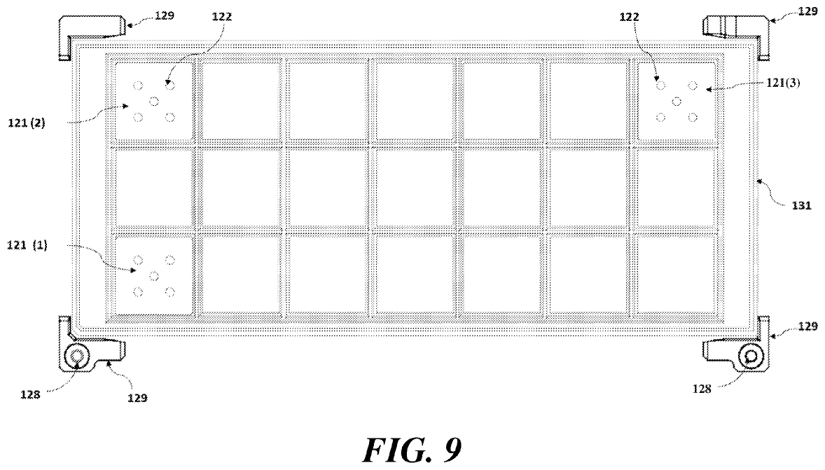

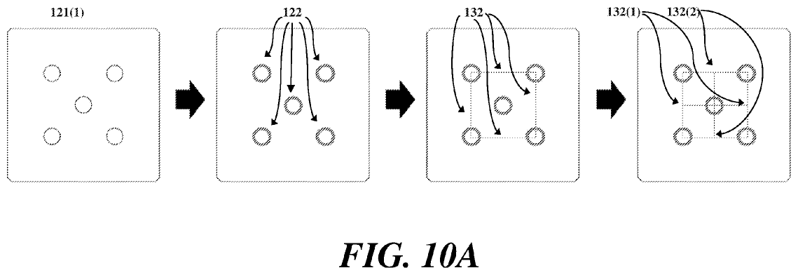

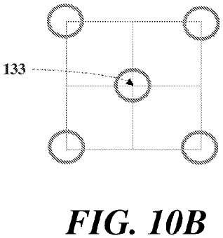

FIG. 9 depicts a tray 131 of DUT coupons for teaching alignment in accordance with the present embodiments, while FIGS. 10A, 10B, 11, 12 and 13 depict views of steps in the method for teaching pick-and-place alignment in accordance with the present embodiments. As the rectangular-shaped tray 131 has an odd number of device holders/sockets in both directions, a minimum of three DUT coupons 121(1), 121(2) and 121(3) are needed to map all of the device holders/sockets of the tray 131 as described hereafter. The centre computer 116 sends a command to move the first pick head with the universal teach kit 100 to a first DUT coupon 121(1) position as shown in FIG. 9. Images of the first DUT coupon 121(1) is captured by the camera 106 as shown in the left image of FIG. 10A and sent to the center computer 116 for determining the center of the DUT coupon in accordance with the present embodiments. Next, the fiducials 122 are located on the image of the DUT coupon 121(1). Then, the centre computer 116 scribes virtual lines 132 between the outside four fiducials 122. Next, first virtual midpoints 132(1) are located on the horizontal virtual lines 132 and second virtual midpoints 132(2) are located on the vertical virtual lines 132. The first and second virtual midpoints 132(1), 132(2) are used to calculate the virtual center 133 of the DUT coupon 121(1) (as shown in FIG. 10B), which is relative to the device holder/socket in the tray 131 and the pick head 124.

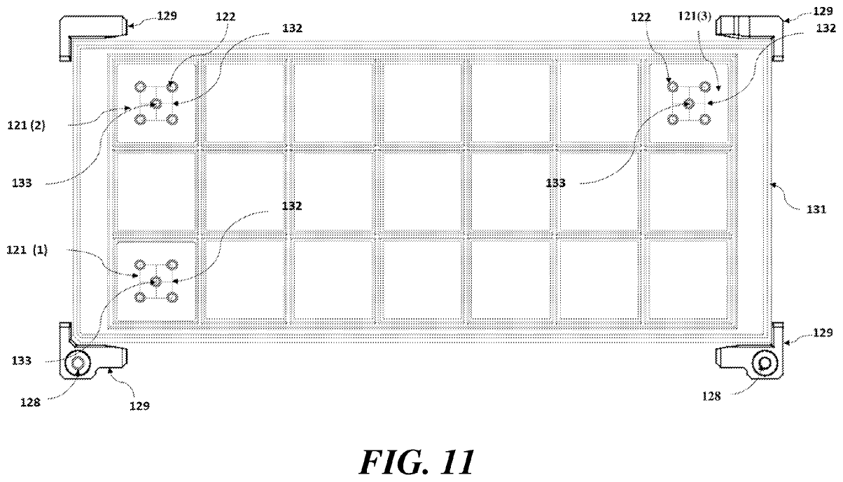

Upon determining the center point 133 of the first DUT Coupon 121 (1), the centre computer 116 sends a command to move the pick head 124 with the universal teach kit 100 to the second DUT Coupon 121(2) location. An image of the DUT coupon 121(2) and its fiducials 122 is captured by the camera 106 and used by the centre computer 116 as shown in FIGS. 10A and 10B to calculate the center 133 of the second DUT Coupon 121(2). Then the same procedure is performed to locate the center 133 of the third DUT coupon 121(3). Thus, all necessary points for teaching alignment of the pick head 124 with the universal teach kit 100 is completed. These necessary points include a total of three DUT center points 133 and one reference datum point 128 as shown in FIG. 11.

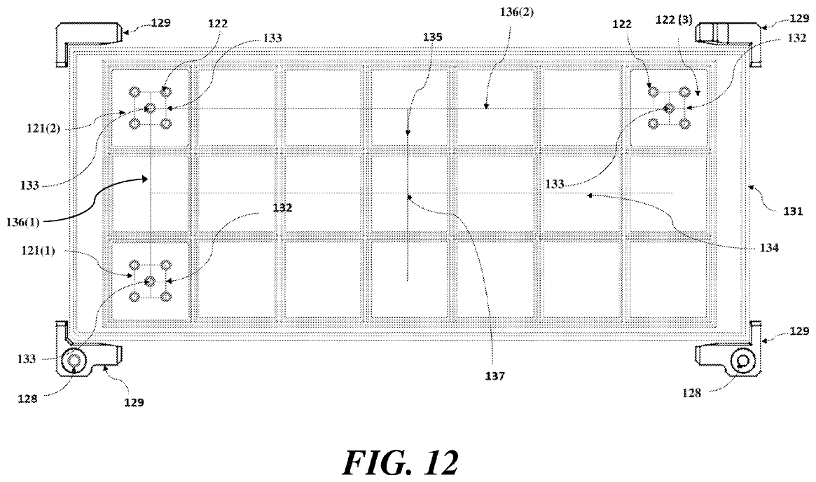

Referring to FIG. 12, the centers 133 and the datum point 128 are used to map the virtual image of the tray 131 for locating a center point of each of the device holders/sockets therein. The mapping of the datum point 128 is used as a reference point. Then, in the virtual image in the centre computer 116, the center point 133 of the first DUT coupon 121(1) and the center point 133 of the second DUT coupon 121(2) are connected by a first virtual vision generated line 136(1). In accordance with the present embodiments, a vision algorithm will determine a midpoint and a perpendicular line 134 from the midpoint inwards. The virtual line 134 will be stored in the vision system.

Next, the center point 133 of the second DUT coupon 121(2) and the center point 133 of the third DUT coupon 121(3) are connected by a second virtual vision generated line 136(2). A midpoint is determined on the second virtual vision generated line 136(2) and a perpendicular line 135 from the midpoint inwards is defined. The point where the inward line 134 and the inward line 135 intersect is defined as the Generated Main Point of Reference 137.

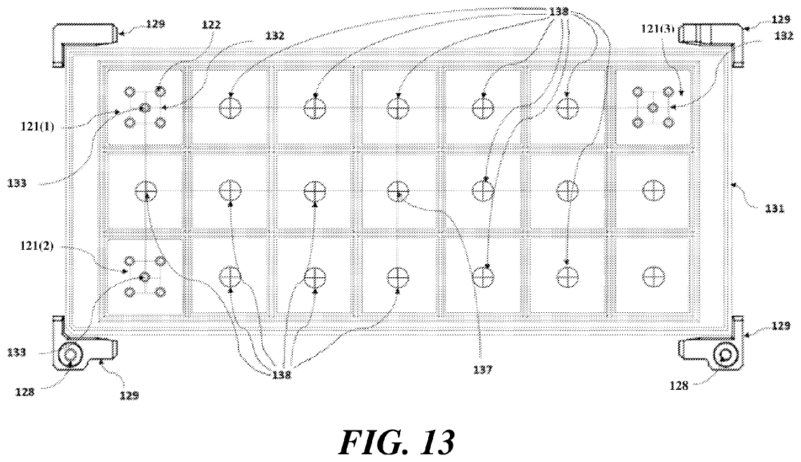

As the tray 131 is a 3×7 tray including twenty-one device holders/sockets, the center points of all twenty-one device holders/sockets are mapped by the centre computer 116. As indicated previously, the Generated Main Point of Reference 137 is located in the center of the tray 131, which is also the center of the center device holder/socket. The centers 138 of the other seventeen device holders/sockets (i.e., all device holders/sockets except the center one and the three holding the three DUT coupons 121(1), 121(2), 121(3)) are generated based on the Generated Main Point of Reference 137. FIG. 13 depicts the locations of the center point of each of the device holders/sockets of the tray 131 mapped by the centre computer 116 using an array function based on a calculated pitch of the device holders/sockets in accordance with the present embodiments. All of the centre points are calibrated positions where the pick-and-place device will either pick or place a substrate, component or DUT into a center point of a device holder/socket of the tray 131. All calibrated positions (i.e., co-ordinates in terms of x, y, z and r) will be uploaded to a database of the centre computer 116 for pick-and-place operations.

In reference to the number of pick-and-place devices in the tooling/machines, all pick-and-place devices will have a universal teach kit 100 mounted on its pick head 124. The above-mentioned methodology and process will be implemented at each pick-and-place device to calibrate the pick head 124 relative to the DUT coupons 121 or other devices to be picked. For example, if there are four pick-and-place devices, each universal teach kit 100 on the pick-and-place device will go through the same teach method as described above. As each pick-and-place devices has different stack up tolerances, the method, system and apparatus in accordance with the present embodiments will advantageously overcome the stack up tolerance of each individual pick-and-place device, generating an independent calibrated pick-and-place without any risk of having external factors in terms of tolerances or assemblies affecting the pick-and-place results and yield.

Also, for efficient operation, in order for continuous usage of the same DUT coupons 121(1), 121(2), 121(3) on a single tray 131, the tray 131 will be transferred serially to each next station where repeat vision data collection and calibration as described above will be done for each pick-and-place device.

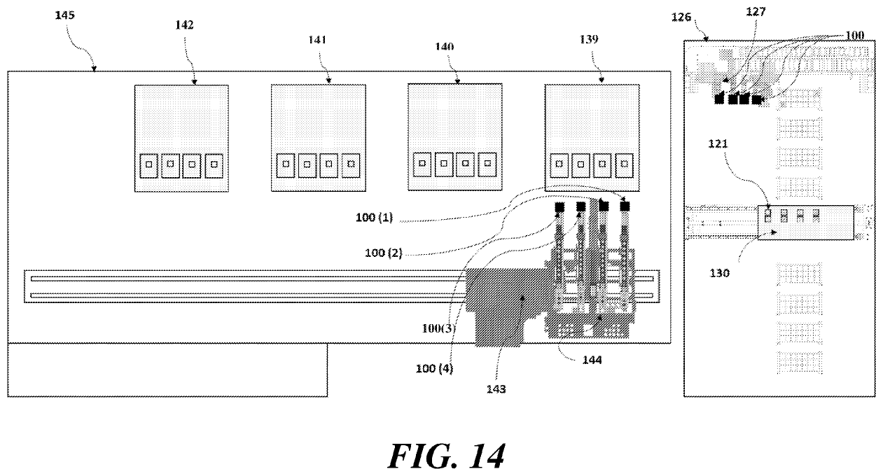

This universal teach kit 100 in accordance with the present embodiment and the alignment and calibration method in accordance with the present embodiments are also applicable to any machines which join together as a complete system or any single machine which involves different modules joining together as a complete system. However, challenges are presented when two modules or two machines or two systems are joined together and need to be synchronized in terms of a single transfer mechanism. FIG. 14 depicts the IO module 126 and a transfer robot (TBOT) and test column 145 as an example of two modules where the universal teach kit 100 and the calibration and teach method create a close loop system in terms of placement and position of product in defined and allocated locations which require synchronization of a transfer mechanism across the connection between the different modules. A product or products are transferred from the IO module 126 by the pick-and-place device 127 with four pick heads through the precisor 130 extension to a TBOT 143 with an end effector 144 designed to pick the product(s) and transfer them to one or more individual test columns 139, 140, 141, 142 in a multi-placement configuration. The transfer needs to occur efficiently and without error, and also the TBOT 143 needs to ensure placement keeps to a boundary geometry of a jig for placement of the product(s) without any out of position (OOP) issues.

The co-relationship between these two modules is challenging when based on using the universal teach kit 100 and the teach method in accordance with the present embodiments which uses virtual center, virtual product outline and virtual boundary through software simulation of best conditions for the placement. Typical methods and apparatuses to resolve and address these challenging issues require one to deploy engineering manpower and time for physical setup and testing different conditions.

FIG. 14 depicts a system where incoming materials/device that are placed on trays or transporting devices on the IO module 126. These devices will be transferred by pick-and-place devices to a buffer station or stage called the precisor 130 based on the design or preset number of parts to be transferred. These devices/substrates/DUTs will be transferred by either a TBOT 143 or a pick-and-place robot from the precisor 130 to the function tester modules (i.e., the test columns 139, 140, 141, 142. The challenge that arises is that the mentioned modules have stack up tolerances from the tray, the holder design, the mechanical movement of the buffer stage precisor 130 either by ball screw and motor drive or by a pneumatic system. All these movements and devices contribute to the stack up tolerances which will eventually have impact on the pick and place position in the function tester module or test columns 139, 140, 141, 142 after the TBOT 143 with an end effector 144 transports the products to the test columns 139, 140, 141, 142.

The above-mentioned engineering challenges are resolved by a closed loop alignment and calibration system and method in accordance with the present embodiments which advantageously resolves the possibility of inaccurate placement issues. The systems, apparatuses and methods in accordance with the present embodiments not only resolves independent module stack up tolerances but also advantageously and efficiently overcomes the stack up tolerances between the two systems/modules. The closed loop alignment and calibration system and method in accordance with the present embodiments is created by using the universal teach kit 100 and using the calibrated position of the pick-and-place from the precisor module 130. The virtual center, the virtual product outline and the virtual boundary are also generated for simulation placement purposes.

The advantage of having the universal teach kit 100 is that the universal teach kit 100 in accordance with the present embodiments can be installed in all of the modules and the calibration can be started, or, after alignment and calibration in one module, the universal teach kit 100 can be removed and installed in the next module without having to invest in a second set of universal test kits 100. For example, after the IO module 126 calibration, the engineering team can remove and install in the universal teach kit(s) 100 in the TBOT 143 with the end effector 144 for the next calibration.

Generally, it is best to have each module have the universal teach kits 100 mounted directly to each of the pick heads 124 to avoid any additional time used for the setup and mounting of the universal teach kit 100.

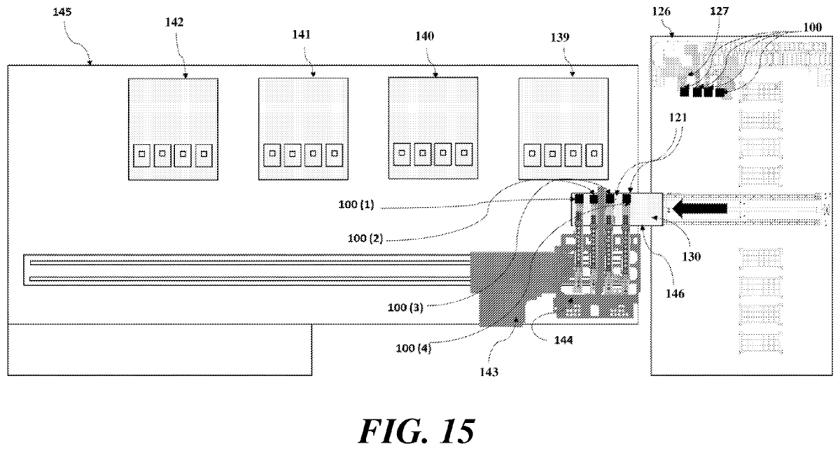

FIG. 15 depicts the transfer mechanism of the closed loop system of FIG. 14 in accordance with the present embodiments. The precisor module 130 is extended to a precisor location 146 and the end effector 144 also moves to the precisor location 146 to pick the DUT coupons 121 from the precisor module 130. Based on the centre computer 116 preset location (from an initial setup), each pick-and-place pick head 124 with the universal teach kits 100(1), 100(2), 100(3), 100(4) will move to the location of the DUT coupons 121 on the precisor module 130.

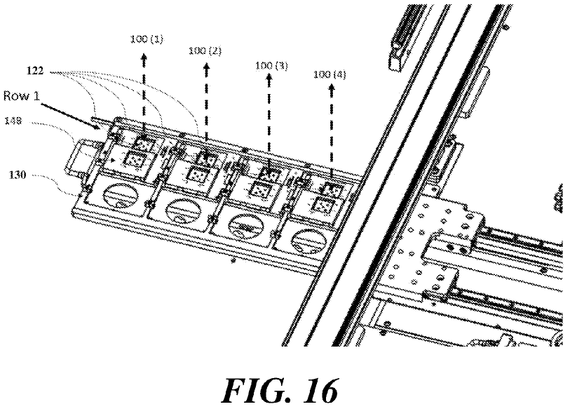

FIG. 16 depicts a first row (Row 1) of the DUT coupons 121 ready to have an image or fiducial captured in accordance with the present embodiments. The four sets of universal test kits 100(1), 100(2), 100(3), 100(4) are shown above each DUT coupon 121 to capture the image of the DUT coupon 121 and the fiducials 122 to calibrate the pick position of the pick-and-place relative to the individual sockets.

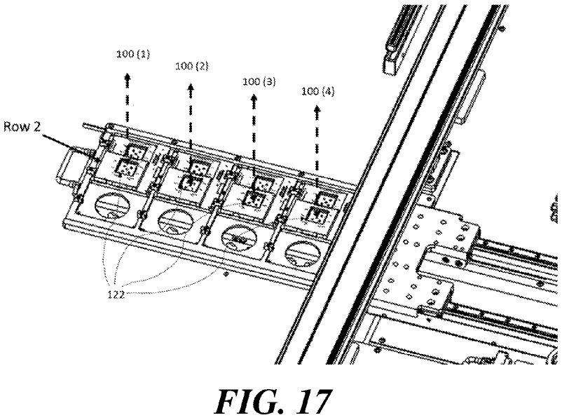

FIG. 17 depicts the DUT coupons 121 on a second row (Row 2). The second row is for pick and transfer of the DUT coupons from the precisor 130 to the test columns 139, 140, 141, 142 by a pick-and-place mechanism of the end effector 144 with y-axis and z-axis movement by the TBOT 143. FIG. 17 shows the same four sets of universal test kits 100(1), 100(2), 100(3), 100(4) moving above each DUT coupon 121. The same steps are repeated, i.e., the DUT Coupon 121 image and fiducials 122 images are captured for calibration of the place position of the pick-and-place relative to the sockets on the precisor 130.

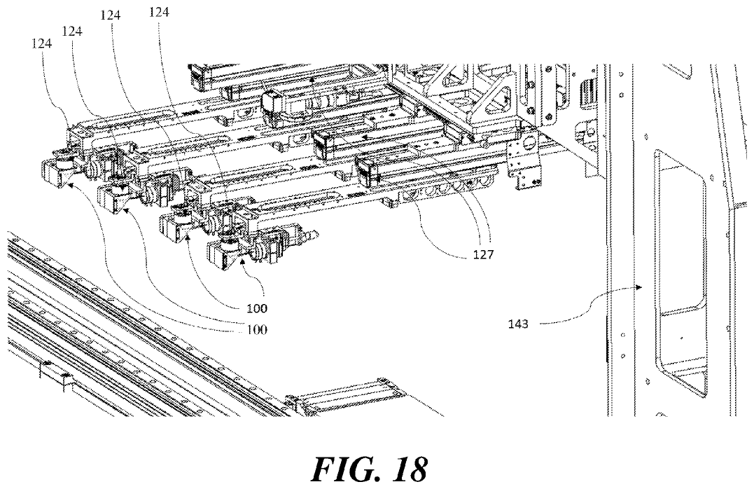

FIG. 18 depicts a perspective view of the TBOT 143 and its transfer modules 127 with the four universal test kits 100 mounted on the pick heads 124 for calibration of place position of the DUT coupons 121 in accordance with the present embodiments.

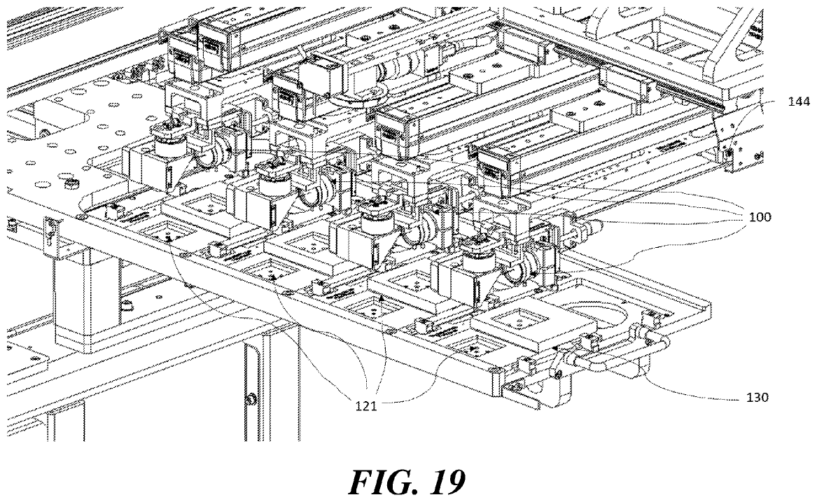

FIG. 19 depicts an enlarged view of the end effectors 144 of the TBOT 143 shows all the universal teach kits 100 mounted to the pick heads above all the DUT coupons 121 in device holders/sockets of the first row (Row 1) of the precisor 130 based on the initial preset location which might have stack up tolerance issues. Using the universal teach kits 100 will directly capture the fiducial 122 images of the DUT coupons 121 which will detect the centre of the device holders/sockets.

In this transfer mechanism example, each of the universal teach kits 100 will capture each of the DUT coupons 121 individually. More specifically, the universal teach kit 100(1) will capture an image of a first DUT Coupon 121 in the first row (Row 1) of the precisor 130, followed by recording of positions for the first pick-and-place and uploading the recorded positions to the centre computer 116 for storing in the data base therein. Once this first step is completed, the universal teach kit 100(2) will proceed to capture an image of a second DUT coupon 121 in the first row, followed by the universal teach kit 100(3) capturing an image of a third DUT coupon 121 in the first row and the universal teach kit 100(4) capturing an image of a fourth DUT coupon 121 in the first row. The same process will be repeated for second row (Row 2) of the precisor. After completion of this image capturing process, the centre computer 116 will have all the pick-and-place locations and co-ordinates for all the device holders/sockets on the precisor (130). In the event that there are more device holders/sockets, all universal teach kits 100 will be required to complete all image scans for all DUT coupons 121 on all the sockets on the precisor 130 and upload the captured data to the centre computing 116.

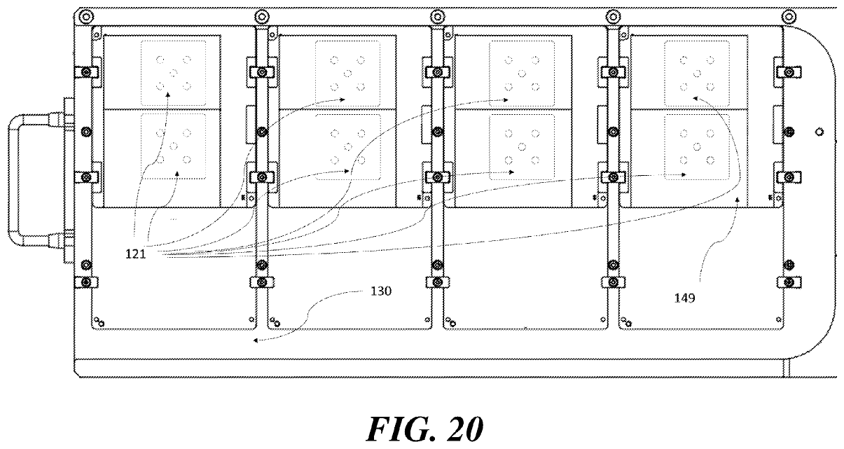

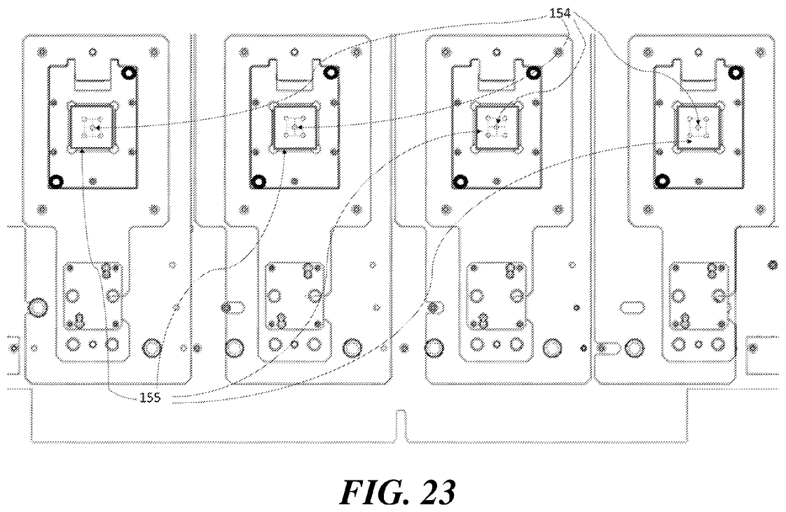

A process and methodology in accordance with the present embodiments is illustrated in FIGS. 20 to 23 where a virtual product outline (VPO) 157 is transferred by the TBOT 143 or robot to the tester column modules 139,140,141,142 with support of the end effector 144. Since individual universal teach kits 100 are mounted to each of pick head 124 on the end effector 144, the image of the fiducials 122 of the DUT coupons 121 that are placed on the test column jigs 152 will be used to either allow (a) manual alignment mode, (b) step alignment mode or (c) auto alignment using the generated VPO 155 as shown in FIG. 23.

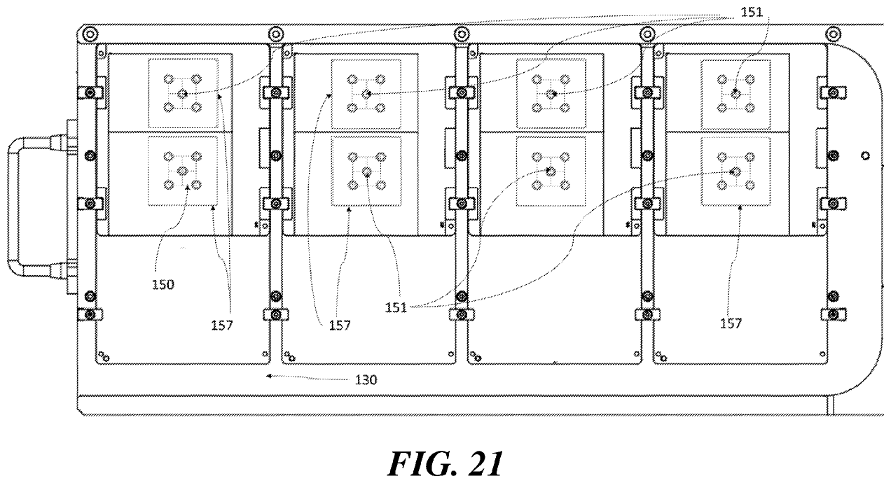

Referring to FIG. 20, the DUT coupons 121 are on fixtures 149 on the precisor 130. The design of the fiducials 122 of the DUT coupons are the same as for the IO module 126 and precisor 130 stage, and can be reused on the test column module. Depending on the number of cavities on each of level of the test columns, each of the universal test kits 100 will need to capture an image and fiducials of all DUT coupons in each of the cavity's sockets or pockets. In FIG. 21, virtual lines 150 are used to locate centers 151 of the DUT coupons 121. The centers 151 of the DUT coupons 121 are used to generate vertical product outlines (VPOs) 157 on the precisor 130.

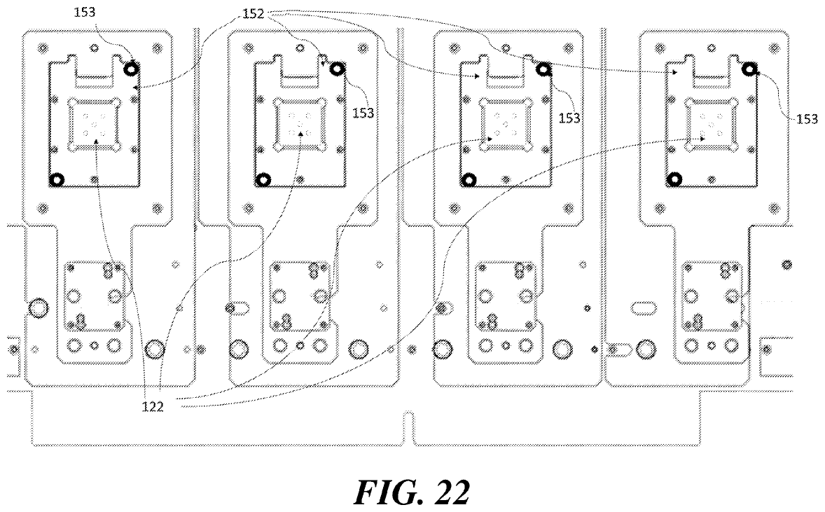

FIG. 22 shows the DUT coupons 121 on fixtures 152 of the test columns 139, 140, 141, 142. Datum fiducials 153 on the fixtures 152 are used as reference points when determining centers of the DUT coupons 121 and virtual product outlines (VPOs) 155 on the test columns 139, 140, 141, 142. FIG. 23 shows the centers 154 generated from the fiducials 122 on the DUT coupons 121. The VPOs 155 on the test columns 139, 140, 141, 142 are generated based on the centers 154 determined by the universal teach kits 100 and the motor control system 118.

Thus, it can be seen that the closed loop system of two modules (the IO module 126 and the TBOT 145 and associated test columns 139, 140, 141, 142) synchronizing, in terms of the transfer mechanism, for pick and place position in accordance with the present embodiments ensures the product placement position is the optimal placement position, especially after the two modules are assembled together. As discussed, after assembly of the two modules, the two-module system is initialized. Next, the visual product outline (VPO) 157, 155 and the calibration data is collected by the universal teach kits 100 for both modules. Once all the points are collected based on the DUT coupon 121 on the jigs or fixtures 149, 148, the centre computer 116 will be able to utilize both the VPOs 157, 155.

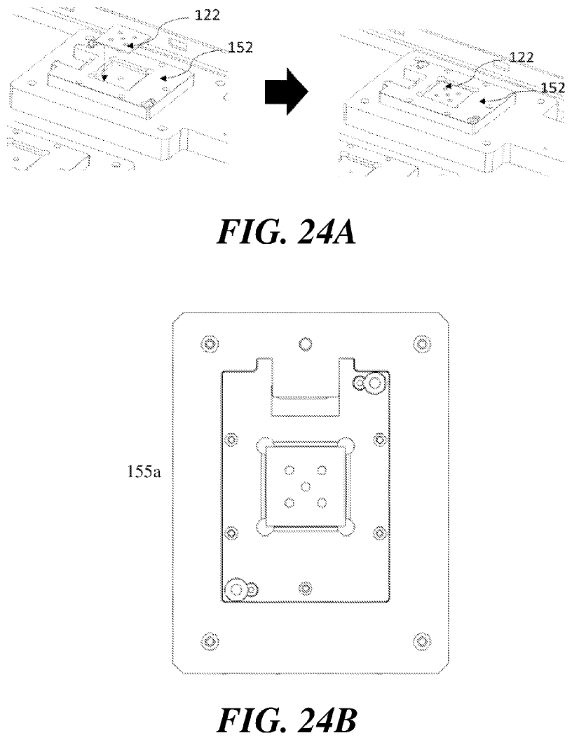

Referring to FIGS. 24A and 24B, a first case study of a pick-and-place operation in accordance with the present embodiments where the DTU coupon 121 is placed squarely within the device holder or socket of the test column jig 152 is depicted. In this first case, the DUT coupon 121 with the fiducials 122 is lowered (lefthand illustration in FIG. 24A) and placed (righthand illustration in FIG. 24A) squarely within the device module or socket of the test column jig or fixture 152. As seen in FIG. 24B, the VPO 155a of the DUT coupon is recorded with the device module/socket of the test column jig 152 squared up as the pick-and place operation as shown in FIG. 24B placed the DUT coupon 121 squarely within the device module/socket of the test column jig 152.

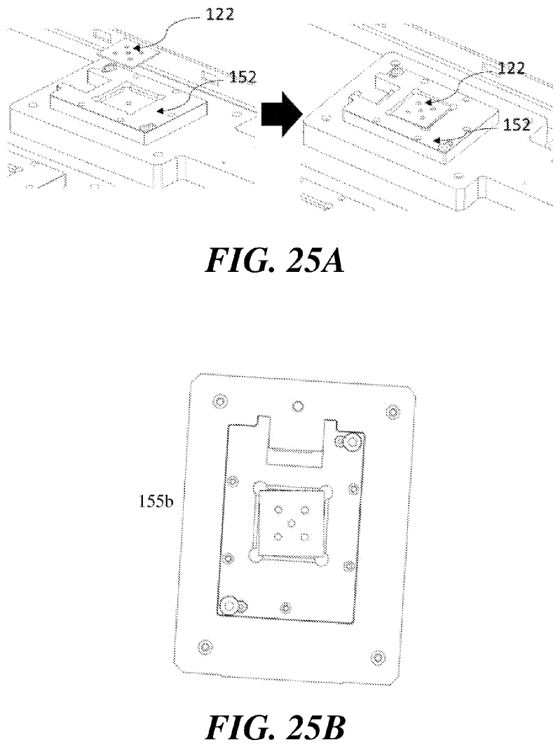

Referring to FIGS. 25A and 25B, a second case study of a pick-and-place operation in accordance with the present embodiments where the DTU coupon 121 is placed out of position (OOP) within the device holder or socket of the test column jig 152 is depicted. In this second case, the DUT coupon 121 with the fiducials 122 is lowered (lefthand illustration in FIG. 25A) and placed (righthand illustration in FIG. 25A) OOP within the device module or socket of the test column jig or fixture 152. As seen in FIG. 25B, the VPO 155b of the DUT coupon is recorded with the universal teach kit 100 over the device module/socket of the test column jig 152 slightly rotated in order to record a squared-up DUT coupon, the rotation of the universal teach kit 100 corresponding to the rotation of the OOP of the pick-and place operation as shown in FIG. 24B placing the DUT coupon 121 within the device module/socket of the test column jig 152.

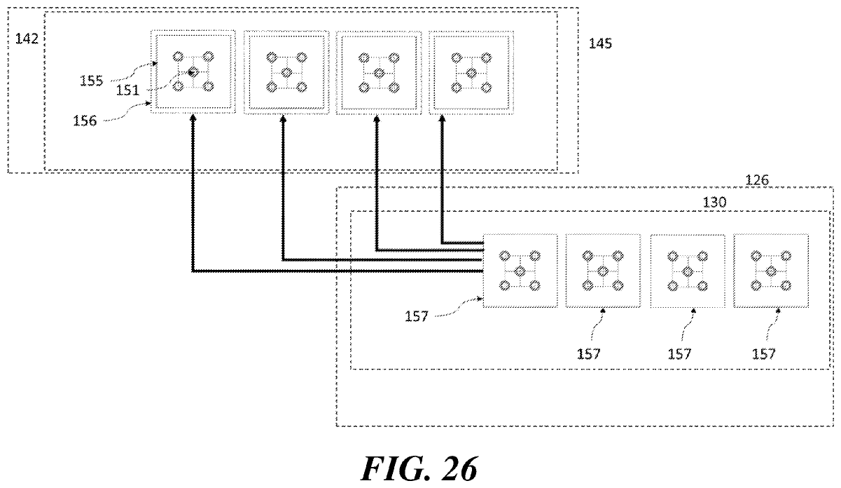

FIG. 26 depicts an illustration of the linkage between the recorded VPOs 157 of the precisor module 130 and the recorded VPOs 155 of the module of the TBOT 145 and one of the test columns 142 in accordance with the present embodiments. Virtual lines 156 indicate a start of a chamfer or a boundary which is a preset boundary limit based on a design of the fixture 152.

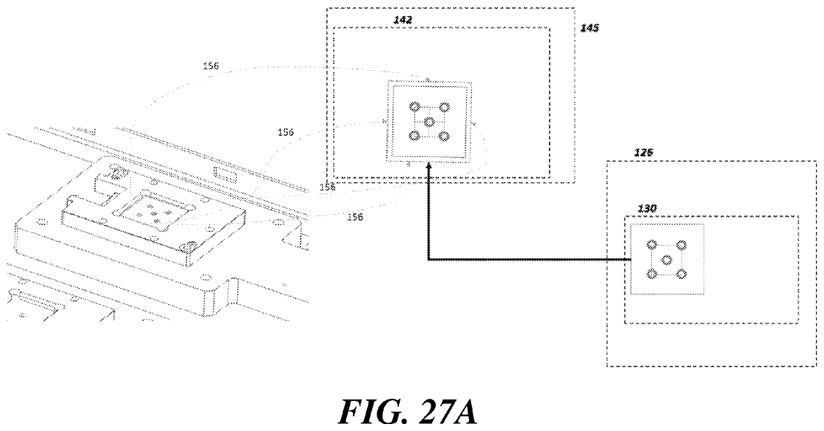

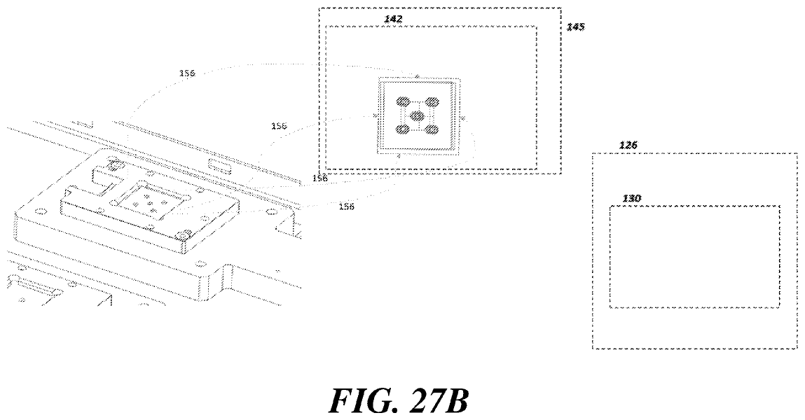

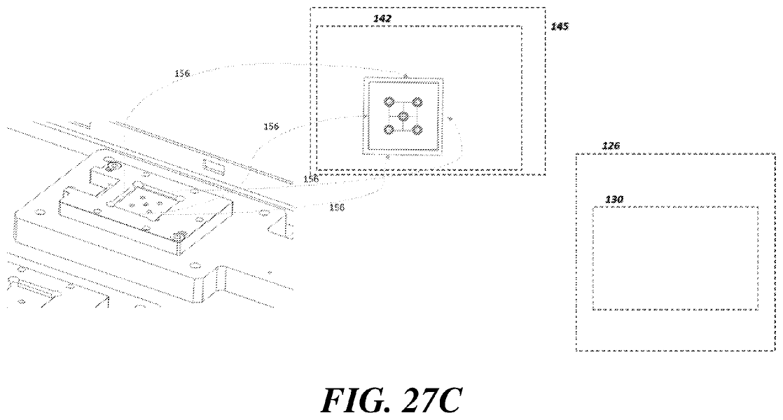

FIGS. 27A, 27B and 27C depict steps in generation of a virtual boundary 156 in accordance with the present embodiments. The virtual boundary 156 determines the position where the product or DUT coupon 121 can optimally be placed in the device holder or socket at ‘a best placement condition’. The reason for a ‘best placement condition’ is due to limitations of the system in rotation of the pick head 124. Different conditions will be simulated and the best condition to place the product based on two VPOs generated with optimal conditions for product placement without OOP. FIG. 27A shows a first virtual boundary 156 of a VPO generated for placement at the test column 142 from the TBOT 145 (as linked with the VPO generated at the precisor 130). FIG. 27B shows adjustment of the virtual boundary 156 of the VPO generated for placement at the test column 142 when optimizing the placement operation to remove OOP. And FIG. 27C shows a further defined virtual boundary 156 of a VPO generated for placement at the test column 142 after adjustment.

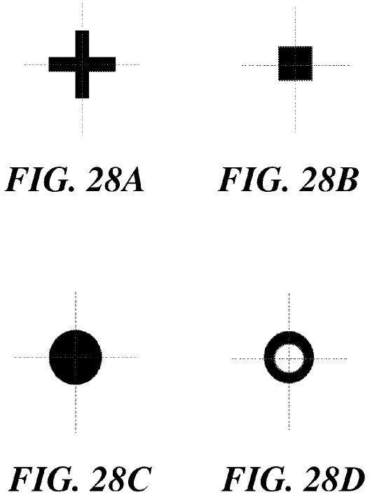

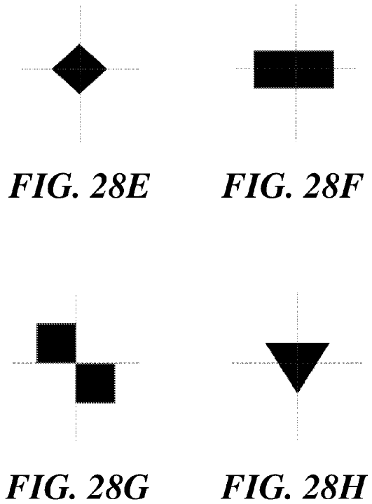

While the fiducial marks 122 depicted in the previous figures have all been circular in shape, the fiducial marks are not limited to this shape. Any different shape of fiducial mark can be used on the calibration tray 131 and the DUT coupons 121 or calibration jigs 148, 149 can be used as long as the camera 106 utilized by the universal tech kit 100 is able to capture an image of the fiducial mark for processing. Thus, any of the fiducial marks depicted in FIGS. 28A to 28H or other similar, easily visible marks can be indented to be used as the fiducial mark 122 or target mark. FIG. 28A depicts a cross fiducial mark, FIG. 28B depicts a square fiducial mark, FIG. 28C depicts a circle fiducial mark, FIG. 28D depicts a double circle fiducial mark, FIG. 28E depicts a rhomb fiducial mark, FIG. 28F depicts a rectangle fiducial mark, FIG. 28G depicts a double square fiducial mark, and FIG. 28H depicts a triangle fiducial mark.

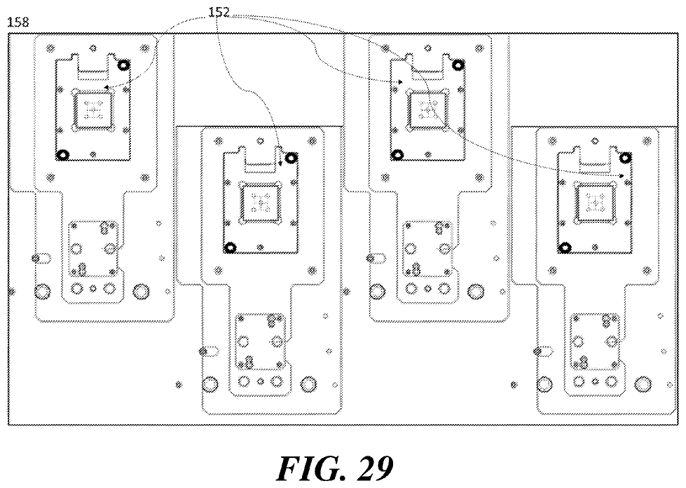

FIG. 29 depicts a different design of a test column 158 having multiple fixture or jigs 152 arranged thereon in accordance with the present embodiments as compared to the test column pictured in FIG. 23.

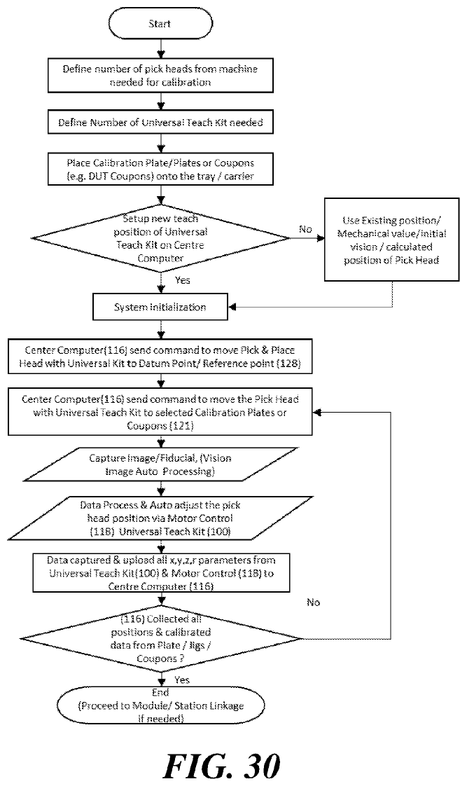

Referring to FIG. 30, a flowchart depicts a calibration process in accordance with the present embodiments which uses the universal test kit 100 to bypass the machine stack up tolerances and generate the actual pick-and-place placement data through the use of defining calibration of jigs 148, 149, trays 131, and DUT coupons 121 with any suitable fiducial marks. Referring to the flowchart of FIG. 30, a total of seven major steps includes the various steps in the flowchart.

First, after determining the number of pick heads 124 needing calibration and, in response thereto defining the number of universal teach kit(s) 100 needed, the universal teach kit(s) 100, including the camera 106, the lens 104 and the camera mount 105 with adjustable mechanisms and the prism 103, are attached individually or interchangingly onto center positions 115 of one or more pick heads 124. Each universal teach kit 100 is attached to the pick head 124 by a mounting bracket 101 customized to fit onto a center of the pick head 124, which is calibrated offline using a universal test kit calibration jig.

As a second major step, all necessary DUT coupons 121 or calibration plates are placed into test sockets, DUT tray 131, a DUT buffer table, a precisor 130, test columns or any functional module that requires a product to be picked and placed on a preset/calibrated position.

Next, the third major step includes successful initialization of the system using a new teach position of the universal teach kit 100 set up on the centre computer 116 or using an existing position or mechanical value or initial vision or calculated position of the pick head(s) 124.

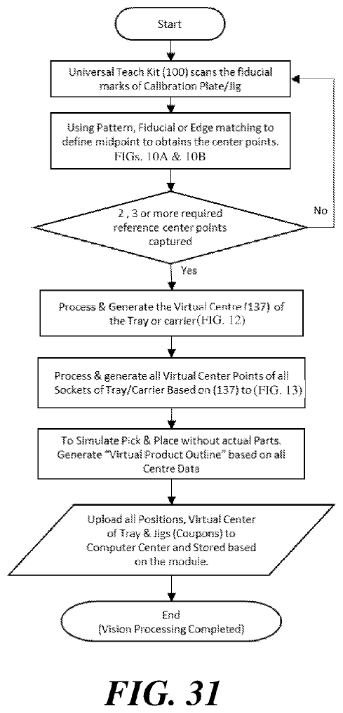

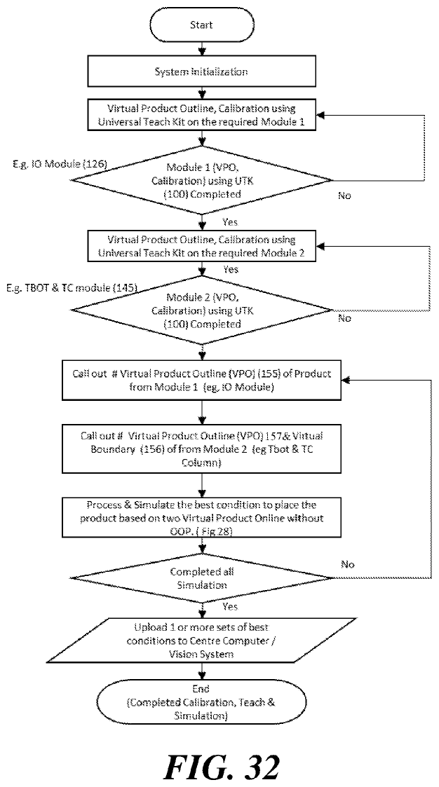

Then, at the fourth major step, the centre computer 116 sends commands to the motor control system 118 to move the pick head towards each pick-and-place position via a mechanical design value or based on the initial vision/calculated position values. The centre computer 116 will auto process an image of the DUT coupon 121 and its fiducial marks 122 captured by the camera 106 of the universal teach kit 100 through the lens 104 and the prism 103 in accordance with a vision image auto processing method (see the flowchart of FIG. 31). In certain cases, the prism 103 can be replaced with another reflective device.

At the fifth major step, the centre computer 116 processes the data and auto adjusts the pick head position of the pick head 124 via the motor control 118 using the universal test kit 100 until the fiducial marks 122 are fully aligned with a center 115 of the pick head/pick-and-place position. The position data is captured/auto recorded and all the x,y,z,r parameters from motor control 118 are uploaded to the centre computer 116 database.

Then at the sixth major step, the steps to teach the pick-and-place positions are repeated until teach all the pick and place positions of all stations are collected (i.e., are uploaded to the centre computer 116).

As a seventh and final major step, all the six major steps (i.e., all the steps of the flowchart of FIG. 30) will be repeated on the rest of the modules in order to obtain the optical/calibrated pick-and-place positions (e.g., the IO module 126 and the precisor 130 stage, and the TBOT 145 and the test column stage).

FIG. 31 depicts a flowchart of the vision image auto processing method in accordance with the present embodiments to generate all center points of all device holders or sockets or slots in a tray (i.e., auto generating the virtual center 138, the virtual product outline 155, 157, and the virtual boundary 156 based on any of the fiducial markings used).

In accordance with the methods of the present embodiments, the vision image auto processing method first uses the universal test kit 100 to scan the fiducial marks 128 of the calibration plate or jig. Then using pattern, fiducial or edge matching the midpoint is defined to obtain the center points 133 as shown in FIGS. 10A and 10B. Once two, three or more required reference center points 133 are captured, processing continues to generate the virtual center 137 of the tray or carrier 131 as shown in FIG. 12. Then, processing continues to generate all of the virtual center points 138 of all of the device holders/sockets of the tray or carrier 131 based on the virtual center 137 of the tray or carrier 131 as shown in FIG. 13. In order to simulate pick-and-place of the parts or DUT coupons 121 without using actual parts, the virtual product outline 155, 157 is generated based on the data of all the virtual centers 138 and all of the positions and virtual centers 137, 138 and the virtual product outline 155, 157 are uploaded to the data base of the centre computer 116 for each module.

FIG. 32 depicts a flowchart of a process to generate a closed loop for pick-and-place positions in a multi module system in accordance with the present embodiments. The process depicted in the flowchart of FIG. 32 ensures that the product placement position is correct in pick-and-place operations in multi module system after the modules are assembled together.

After system initialization, the virtual product outlines 157 are generated and calibrated using the universal teach kit(s) 100 on pick heads 124 at the first module (e.g., the IO module 126). Once the virtual product outlines 157 are generated and calibrated for the first module, the virtual product outlines 155 are generated and calibrated using the universal teach kit(s) 100 on pick heads 124 at the second module (e.g., the TBOT and test column module 145).

After the virtual product outlines 157 are generated and calibrated for the second module, a first virtual product outline (VPO) 155 of the product at the first module and a first virtual product outline (VPO) 157 of the product at the second module are processed to simulate a best condition to place the product based on the two VPOs without the product being placed out of position (OOP). Then simulations on all subsequent pairs of VPOs at the two modules are run. When all simulations are completed, one or more sets of the best conditions are uploaded to the centre computer 116 vision system.

Thus, it can be seen that the systems, apparatus and methods in accordance with the present embodiments provide a universal teach kit 100 and a unique calibration teach method which helps to predict the possibility of OOP and failure due to tolerance stack up and setup issues. To be able to measure risk and performance of a machine or tool, data collection is critical for the measurement. The universal teach kits 100 in accordance with the present embodiments are not only applicable to machines and tooling in a setup phase in a factory or plant locally, but also applicable to all machines or tools that are onsite to address the setup issues and to reduce engineering time and trial runs. In addition, based on data collected from the universal teach kit 100 in terms of the virtual center, the virtual product outline (VPO) and the positioning data collected. Different product sizes and shapes can be addressed by the systems, apparatus and methods in accordance with the present embodiments as the generates virtual center is defined based solely on the vision system of the universal teach kit 100. The VPO can also be changed based on different products and can be simulated to determine if there are any risk in misalignment or OOP by the systems, apparatus and methods in accordance with the present embodiments without the need of physical or actual product change over.

In summary, the universal teach kit 100 the methodology of the teach and calibration method in accordance with the present embodiments reduces the overall time needed for setup, reduces the ability to use a physical or actual product to validate the complete machine setup, and can advantageously generate a closed loop between different modules or different system. Moreover, the systems, apparatus and methods in accordance with the present embodiments provide increased safety during setup as the simulations are done by data and image collection from the machine and not actual product pick-and-place steps. In addition, an offline study can also be conducted based on the simulations and different condition of the pick-and-place positions to decrease or completely remove the possibly of OOP issues.

Feasibility studies to improve the yield rate can also be analyzed in accordance with the present embodiments. To measure the pick-and-place yield and overall machine efficiency, the universal teach kit 100 bridge bridges multi systems and/or multi modules to generate a closed loop multi system in terms of product transportation thereby overcoming the stack up tolerance in the integrated multi system.

Additionally, it is contemplated that positioning of all products to the sockets and trays can be simulated or emulated in regards to a drop condition based on the physical design of the product. Further, CAD simulation software can use the position and placement based on the data collected from the universal teach kits 100.

The systems, apparatus and methods in accordance with the present embodiments will not only benefit the semiconductor industry but also can be used with any machines that have pick heads and need to transfer products throughout different modules in a system. Modification of the universal teach kit 100 can be done through sizing and selection of the cameras 106, the lens 104 and the prism 103 in consideration of any and all space constraints of the machine or tooling.

While exemplary embodiments have been presented in the foregoing detailed description of the present embodiments, it should be appreciated that a vast number of variations exist. It should further be appreciated that the exemplary embodiments are only examples, and are not intended to limit the scope, applicability, operation, or configuration of the invention in any way. Rather, the foregoing detailed description will provide those skilled in the art with a convenient road map for implementing exemplary embodiments of the invention, it being understood that various changes may be made in the function and arrangement of steps and method of operation described in the exemplary embodiments without departing from the scope of the invention as set forth in the appended claims.

1. A universal teach apparatus for teaching pick-and-place positions, the universal teach apparatus comprising:
a reflective material;
a camera located in relation to the reflective material to receive image information from a first reflective face of the reflective material;
means for mounting the universal teach apparatus onto a pick head of a pick-and- place machine with a second reflective face of the reflective material facing the pick head; and
adjustment means coupled to one or both of the camera and the reflective material and configured to adjust a field of view of the camera to view the reflective material, configured to adjust a focal distance of the camera to focus on the reflective material, and/or configured to adjust a center of the second reflective face of the reflective material with a center of the pick head.

2. The universal teach apparatus in accordance with claim 1, wherein the reflective material comprises a 45-degree prism, and wherein the first reflective face of the reflective material comprises a 45-degree face of the 45-degree prism.

3. The universal teach apparatus in accordance with claim 1, further comprising a lens coupled to the camera, wherein the adjustment means is coupled to the camera and the lens and configured to adjust a field of view of the camera and the lens to view the reflective material and/or configured to adjust a focal distance of the camera and the lens to focus on the reflective material.

4. The universal teach apparatus in accordance with claim 1, wherein the image information comprises image information of an item to be picked by the pick head.

5. The universal teach apparatus in accordance with claim 1, wherein the adjustment means includes a locking means to prevent movement or rotation of the adjustment means after manual manipulation thereof.

6. The universal teach apparatus in accordance with claim 5, wherein the locking means comprises a wedge locking washer.

7. The universal teach apparatus in accordance with claim 1, wherein the means for mounting the universal teach apparatus onto the pick head of the pick-and-place machine comprises mounting elements including a counter balance.

8. The universal teach apparatus in accordance with claim 1, wherein a form factor of the universal teach apparatus is determined in response to the pick head and the pick-and-place machine.

9. A system for pick-and-place calibration of a pick-and-place machine comprising:
a universal teach apparatus for teaching pick-and-place positions and coupleable to a pick head of the pick-and-place machine, the universal teach apparatus comprising imaging means for capturing images in-line with a center of the pick head;
a computing means coupled to the universal teach apparatus for receiving the captured images and configured to generate at least one virtual image corresponding to one or more parameters of the captured images; and
motor control means coupled to the computing means, the pick head of the pick-and-place machine, and the universal teach apparatus and configured to move the pick head under control of the computing means and/or the universal teach apparatus, wherein during a process of teaching pick-and-place positions, the computing means is configured to adjust a pick head position via the motor control means based on alignment of the center of the pick head with the at least one virtual image and is further configured to record a plurality of coordinate parameters corresponding to position data of the motor control means when the center of the pick head fully and accurately aligns with the at least one virtual image.

10. The system in accordance with claim 9, wherein the at least one virtual image corresponding to the one or more parameters of the captured images that the computing means is configured to generate are selected from a group of virtual images comprising a virtual product outline of a product to be picked, a virtual center of the product, a virtual center point of a tray configured to hold the product to be picked, a virtual line, a virtual midpoint, and a virtual boundary.

11. The system in accordance with claim 9, wherein the one or more parameters of the captured images are selected from a group of parameters comprising a fiducial mark on a tray, a fiducial mark on a device on the tray, and an outline of the device on the tray.

12. The system in accordance with claim 11, wherein the fiducial mark on the tray and/or the fiducial mark on the device on the tray comprises a five-point fiducial mark square-shaped design comprising one mark at a center point of the five-point fiducial mark square-shaped design and four points at each corner of the five-point fiducial mark square-shaped design.

13. The system in accordance with claim 9, wherein each of the plurality of coordinates which the computing means is configured to record are selected from a group of coordinates comprising an x-axis coordinate, a y-axis coordinate, a z-axis coordinate and a rotation coordinate.

14. A method to resolve stack up tolerances in a machine assembly comprising a pick-and-place machine and using a universal teach apparatus including an image capturing device, the method comprising:
mounting the universal teach apparatus to a pick head of the pick-and-place machine;
using the image capturing device of the universal teach apparatus to capture images of defined markings on one or more products to be picked by the pick-and-place machine and/or trays for holding the products to be picked, wherein the defined markings comprise fiducial markings;
generating one or more virtual parameters from the captured images, the one or more virtual parameters corresponding at least to a center of the one or more products and/or trays and a size and/or shape of the one or more products and/or trays;
generating a virtual product outline based one the one or more virtual parameters; and
calibrating the pick-and-place machine in response to the virtual product outline to resolve stack up tolerances of a pick-and-place operation of the pick-and-place machine.

15. The method in accordance with claim 14, wherein the step of mounting the universal teach apparatus to the pick head of the pick-and-place machine comprises calibrating the universal teach apparatus to have a vision center of the universal teach apparatus aligned with a center of the pick head of the pick-and-place machine.

16. The method in accordance with claim 14, wherein the machine assembly comprises a plurality of pick-and-place machines, and wherein the step of mounting the universal teach apparatus to a pick head of the pick-and-place machine comprises mounting one of a plurality of universal teach apparatuses to a pick head of each of the plurality of pick-and-place machines, and wherein each of the steps thereafter are performed for each of the plurality of universal teach apparatuses.

17. The method in accordance with claim 14, wherein the machine assembly comprises multiple modules of pick-and-place machines, and wherein the steps of mounting the universal teach apparatus, using the image capturing device of the universal teach apparatus to capture the images of the defined markings, generating the one or more virtual parameters from the captured images, and generating the virtual point outline are performed for each of the multiple modules of pick-and-place machines, and wherein the step of calibrating the pick-and-place machine in response to the virtual product outline to resolve stack up tolerances comprises linking the multiple modules together to calibrate the pick-and-place machines of the multiple modules of pick-and-place machines to resolve stack up tolerances in the multiple modules of pick-and-place machines by overlapping the virtual point outlines generated for each of the multiple modules of pick-and-place machines.
